(19) United States
(12) Patent Application Publication
(10) Pub. No.: US 2015/0217316 A1
(43) Pub. Date: Aug. 6, 2015

(54) MEASUREMENT AND PROTECTIVE APPARATUS FOR COATING PROCESSES

(71) Applicant: SIEMENS AKTIENGESELLSCHAFT, München (DE)

(72) Inventors: Tobias Brett, Schonefeld (DE); Sascha Martin Kyeck, Berlin (DE); Johannes Richter, Berlin (DE); Christian Sönnichsen, Falkensee (DE)

(21) Appl. No.: 14/419,866

(22) PCT Filed: Feb. 20, 2013
(86) PCT No.: PCT/EP2013/053303

§ 371 Date: Feb. 5, 2015

(30) Foreign Application Priority Data
Aug. 10, 2012 (DE) 102012214278.9

(51) Int. Cl. B05B 12/08; C23C 4/12; B05B 15/04

(52) U.S. Cl. CPC B05B 12/084; B05B 15/0437; B05B 15/0443; C23C 4/12

(57) ABSTRACT

Due to the mechanical decoupling of protection device and weighing device, it is possible for the first time to measure the blade weight during the coating process.

The invention relates to an apparatus of a coating installation which makes it possible both to protect certain regions of the component from the coating and also to carry out weight measurements.

In thermal spraying methods for coating gas turbine blades or vanes, ceramic and/or metallic powder is melted completely or partially in a hot gas jet and applied with a high kinetic energy to the blade or vane. The technical challenge of the process consists in achieving a bond between the layer and the base material and also reproducible layer thicknesses and layer porosity. Direct process parameters are the layer weight, the layer thickness and porosity and roughness. At present, none of these parameters is monitored during the process. Instead, the parameters are measured retrospectively or anticipated on the basis of indirect measurements, for instance by measuring the torch jet.

The measurement of the layer weight during the process is hindered significantly by the design of the common clamping and holding apparatuses. The protective wall of the clamping system is in physical contact with the blade or vane and is itself subjected to a change in weight during the process through what is termed overspray. Moreover, a weighing module cannot be accommodated in the apparatuses, since precise measurements are impaired by severe changes in temperature and also powder dust in the inner space.

It is therefore an object of the invention to solve or to further improve the aforementioned problem.

This object is achieved by an apparatus as claimed in claim 1 and a method as claimed in claim 8.

The present invention realizes a physical decoupling of the protective sleeve and the blade or vane through the principle of shading. The inner space is preferably protected against dust by excess pressure and the compressed air which flows in keeps the inner space at a constant temperature. A weighing module for carrying out a precise measurement of a blade or vane can therefore be accommodated in the inner space. The protective sleeve can consist of a plurality of layers, the coating material not bonding to the outer layer of, for example, tungsten material. In order to ensure the economic viability of this design concept, the apparatus has an adaptive configuration, so that it is possible for various types of rotor blade to be clamped.

By measuring changes in layer weight at any desired zones of the blade or vane, it is possible to work out the layer thickness. The process can be regulated specifically, such that the blade or vane can be coated with considerably tighter manufacturing tolerances. The quality of the layer application is improved. As a side effect of the aforementioned shading principle, it is possible to prevent overspray on the edge of the blade or vane.

A further feature according to the invention is a flexible sensor/actuator system, which is integrated with the machine and with which effectively applied material can be measured and an installation control system can perform layer formation conforming to specifications.

The inventive step lies in a series of structural measures which make it possible to carry out the measurement under the rough ambient conditions in the APS/HVOF booth and in the process also promote the formation of a bevel conforming to specifications at the root edges.

In operational practice, the blade or vane surface is typically divided into a plurality of zones each characterized by different types of defect, for example the root plate pressure side. The torch performs up to ten passes in a zone and in the process applies in each case a layer measuring approximately 2 mg. If the quantity of effectively applied material per zone and pass can be measured, it is thus possible for conclusions to be made directly in relation to conventional cases of defect in this zone and for these to be compensated for directly by control engineering. If, for example, there is a reduced layer weight in one zone and an increased layer weight in a second zone, this can be sensed and compensated for immediately for each zone. This procedure would be advisable particularly when an automatic correction of the blade or vane position has also been carried out and the torch jet parameters have automatically been checked.

During a coating operation, the installation control system can therefore identify all the influencing variables required for a coating conforming to specifications and, if appropriate, independently adjust or control the process. The adjustments made to the installation may be checked retrospectively by a laser triangulation measurement. In conjunction with the measurement of the layer thickness, the local layer weight allows for a sufficiently accurate calculation of the porosity.

It is thereby possible to dispense entirely with a metallographic evaluation of tabs in retrofitting operations.

An essential requirement of the system is the protection of the sensitive weighing sensor technology against the rough ambient conditions and also the mechanical separation of the blade or vane from the protective enclosure. Since the system has a more complex design than conventional apparatuses, it is necessary for the system to be flexible for many types of blade or vane, in the present case to be suitable for all rotor blades. The blade or vane edges are not protected by contact-making metal sheets, but instead by a contactless adaptive shielding plate, which makes it possible to perform the coating with a bevel conforming to specifications rather than material accumulation.

Since a protective sleeve is not in contact with the blade or vane, the change in weight of the blade or vane can be measured without the change in weight of the protective sleeve. The protective sleeve is subject to a change in weight since unintended coating of the protective enclosure cannot be prevented in practical operation.

The dependent claims list further advantageous measures which can be combined with one another as desired in order to achieve further, aforementioned advantages.

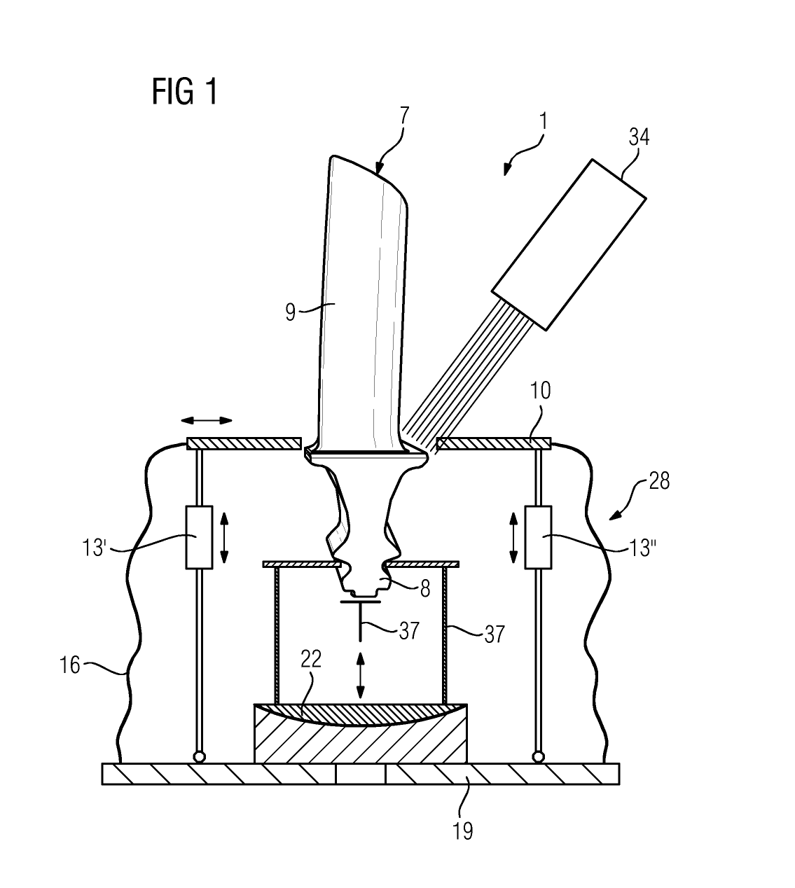

FIG. 1 shows an apparatus according to the invention,

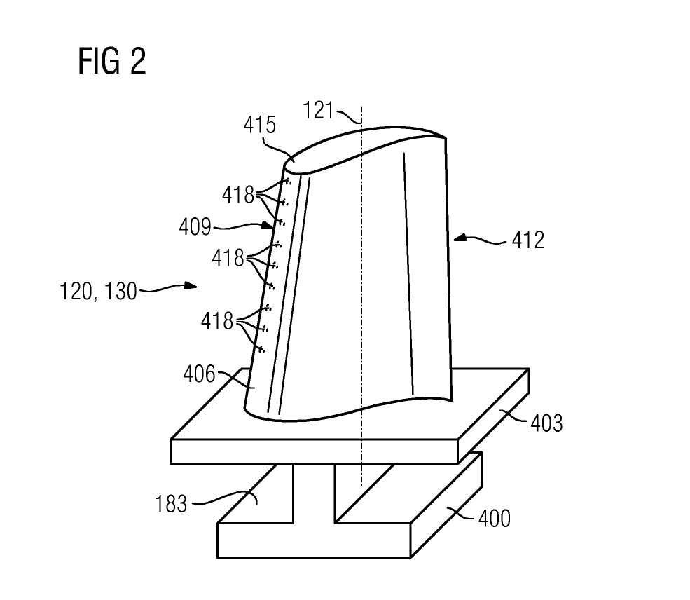

FIG. 2 shows a turbine blade or vane.

The figures and the description represent merely exemplary embodiments of the invention.

### Apparatus:

FIG. 1 shows an apparatus 1 according to the invention, which has a modular configuration in respect of the measurement 22 and protective options 10, 16, 28, preferably also in the case of the clamping 37.

The apparatus 1 is part of a coating installation, which is not shown in more detail here.

Provision can therefore be made of an outer enclosure for coating in vacuo, a robot for moving a coating nozzle 34 and also further parts.

A component 7, here preferably a turbine blade or vane 120, 130 (FIG. 2), which is to be coated is simultaneously measured during the coating or at the end of the coating operation.

For this purpose, there are firstly a clamping apparatus 37 and a weighing module 22 and also a protective sleeve 28, which are mechanically or physically separated from one another.

The clamping apparatus 37 is mechanically connected to the weighing module 22 and is configured in such a way that it can be adapted flexibly to various components 7, 120, 130.

The clamping apparatus 37 acts on appropriate faces of the component 7, 120, 130.

The weighing module 22 can measure the changed weight during the coating or during a coating interval and forward the result to a computer, in order if appropriate to continue the coating, change the coating or allow the coating to end.

The component 7, 120, 130 is not intended to be coated completely.

The shielding plate 10 arranged at the top lies opposite a coating nozzle 34 and shields an entire bottom region 8 of the component 7, 120, 130. The shielding plate 10 (plate with an opening for the component 7, 120, 130 or in two parts) rests against the component 7, 120, 130. The shielding plate 10 can be replaced quickly and is adapted to various types of components 7, 120, 130. The shielding plate 10 can be varied in the plane and in the height of the component 4, 120, 130, in order for example to generate a phase of the coating on an edge, here the edge of the platform 403 of a turbine blade or vane 120, 130.

Only the top part 9 of the component 7, 120, 130 is intended to be coated. The top part 9 and bottom part 8 (in the case of turbine blades or vanes 120, 130, the blade or vane root 183, 400) represent the entire component 7, 120, 130.

The shielding plate 10 is adjoined by a non-rigid, flexible sleeve 16 affording protection against temperature and dust, the flexible sleeve 16 then being connected to the shielding plate 10 and the component 9.

The shielding plate 10 is supported on the base 19, but is not mechanically connected to the weighing module 22.

In the case of a turbine blade or vane 120, 130, the blade or vane root 183, 400 is not intended to be coated, and therefore the shielding plate 10 is arranged at the height of the blade or vane platform 403 and can be adjusted in height, if appropriate, by actuators 13′, 13″.

### Method:

If the component 7, 120, 130 has been clamped, the initial weight is measured and the coating is started here by means of a coating nozzle 34.

A component 7, 120, 130 is coated layer by layer and the blade or vane weight can be measured after each zone, for each layer or a plurality of layers in order to establish deviations from the desired process so as to be able to intervene already during the process, so that the desired layer thickness or layer weight is achieved at the end after all coating layers of all forms have been applied.

During the coating, cooling air or protective gas can be blown out underneath the shielding plate 10 through the gap which is inevitably always present between the shielding plate 10 and the component 7, 120, 130, in order to prevent a coating in the gap.

Similarly, the weighing module 22 can be deactivated, in particular fixed, during the coating, such that there is a rigid connection between the base plate 19, the weighing module 22 and the clamping apparatus 37.

There is preferably a break in the coating during the measurement of the weight.

FIG. 2 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses. Single-crystal workpieces of this type are produced, for example, by directional solidification from the melt. This involves casting processes in which the liquid metallic alloy solidifies to form the single-crystal structure, i.e. the single-crystal workpiece, or solidifies directionally. In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation, e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer.

Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed.

If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

1. An apparatus for weighing and protecting a component during coating of the component, comprising:
a weighing module configured for measuring the component;
a protective sleeve or covering located and configured for protecting at least a part of the component from the coating during coating; and
the weighing module is mechanically decoupled from the protective sleeve.

2. The apparatus as claimed in claim 1, further comprising:
the protective sleeve comprises at least one shielding plate starting at a selected height of the component to be coated, wherein the shielding plate is located and configured to shield a bottom part of the component below the selected height against coatings.

3. The apparatus as claimed in claim 2, further comprising:
the protective sleeve includes a flexible sleeve arranged as part of the protective sleeve and the flexible sleeve extends between the shielding plate and a base plate of the apparatus, the protective sleeve runs at an angle which differs from 0° , with respect to the shielding plate, and the protective sleeve is exposed to the coating material in order to achieve a dust, pressure and temperature barrier toward the part of the component in the protective sleeve.

4. The apparatus as claimed in claim 2, further comprising:
an actuator configured to adapt the shielding plate in its height with respect to the component to be coated.

5. The apparatus as claimed in claim 1, further comprising a clamping apparatus located and configured for clamping to and supporting the component with respect to the weighing module;
wherein the clamping apparatus is mechanically decoupled from a protective sleeve and has a modular form.

6. The apparatus as claimed in claim 5, wherein the clamping apparatus is arranged on the weighing module.

7. The apparatus as claimed in claim 5, wherein the clamping apparatus is adaptable to the weighing of various components.

8. A method for coating a component using an apparatus as claimed in claim 5, and the method comprising measuring the layer weight without removing the component from the clamping apparatus during the coating.

9. The method as claimed in claim 8, further comprising during the coating, blowing air in a direction of a coating material from a gap between a shielding plate of a protective sleeve and the component to be coated.

10. The method as claimed in claim 8, further comprising measuring a layer weight after each coating layer or after a selected number of coating layers, and comparing the measured weight with a nominal value.

11. The method as claimed in claim 8, further comprising deactivating the weighing module during the coating and activating the weighing module when coating is not being performed.

12. The method as claimed in claim 10, wherein the coating parameters are adapted to a coating nozzle.

13. The apparatus as claimed in claim 2, further comprising:
the protective sleeve includes a flexible sleeve arranged as part of the protective sleeve and the flexible sleeve extends between the shielding plate and a base plate of the apparatus, the protective sleeve runs at an angle which differs from 90° , with respect to the shielding plate, and the protective sleeve is exposed to the coating material in order to achieve a dust, pressure and temperature barrier toward the part of the component in the protective sleeve.
